(19) United States
(12) Patent Application Publication
(10) Pub. No.: US 2015/0185176 A1
(43) Pub. Date: Jul. 2, 2015

(54) HUMIDITY SENSOR AND MANUFACTURING METHOD THEREOF

(71) Applicant: SAMSUNG ELECTRO-MECHANICS CO., LTD., Suwon-Si (KR)

(72) Inventors: Tae Kon KOO, Suwon-Si (KR); Tae Hoon KIM, Suwon-Si (KR)

(73) Assignee: SAMSUNG ELECTRO-MECHANICS CO., LTD., Suwon-Si (KR)

(21) Appl. No.: 14/221,007

(22) Filed: Mar. 20, 2014

(30) Foreign Application Priority Data
Dec. 26, 2013 (KR) 10-2013-0163654

(51) Int. Cl. G01N 27/22

(52) U.S. Cl. CPC G01N 27/223

(57) ABSTRACT

There is provided a humidity sensor including: a substrate including an insulation film deposited on a surface thereof; a lower electrode formed on the substrate and including a contact extension part; a moisture sensing layer formed of a polymer material, provided on the lower electrode, and partially exposed through the contact extension part; and an upper electrode formed on the moisture sensing layer and including an open portion so as to partially expose the moisture sensing layer, wherein the contact extension part is in communication with the outside so that external air contacts the moisture sensing layer exposed through the contact extension part.

### CROSS-REFERENCE TO RELATED APPLICATION

This application claims the benefit of Korean Patent Application No. 10-2013-0163654 filed on Dec. 26, 2013, with the Korean Intellectual Property Office, the disclosure of which is incorporated herein by reference.

### BACKGROUND

The present disclosure relates to a humidity sensor, and more particularly, to a humidity sensor including a moisture sensing layer of which a contact area with external air is increased, and a manufacturing method thereof.

Generally, a sensor is a device sensing/detecting various kinds of physical quantities such as temperature, pressure, sound, light, or the like, or a detector using such a device. Particularly, a sensor sensing/detecting an amount of water vapor in the air is referred to as a humidity sensor.

Such a humidity sensor has been manufactured to have various structures, but a structure in which a thin film detecting moisture is provided, in which a degree of electrical conductivity of the thin film is changed in the case in which the thin film is exposed to moisture is provided has mainly been used.

In this case, a polymer thin film such as a polyimide thin film, or the like, may be used as a humidity sensing film. Recently, such a polymer thin film has been used as a material for replacing existing thin films. However, since it is difficult to obtain electrical conductivity properties in the polymer thin film itself, the polymer thin film is formed on a further thin film, and then, a phenomenon in which electrical conductivity properties are changed by deformation of the polymer thin film is utilized.

Describing a method of measuring humidity, firstly, a lower electrode for a humidity sensing device is formed by depositing and patterning a metal film on a substrate, and a humidity sensing film is formed on the lower electrode. Then, an upper electrode for a humidity sensing device is formed by depositing and patterning a metal film formed of the same material as that of the lower electrode on the humidity sensing film, such that the humidity sensor has a parallel plate capacitor structure in which the humidity sensing film is provided between the upper and lower electrodes.

Here, a partially open portion may be formed in the upper electrode in order to allow water molecules to pass into the humidity sensing film.

In this case, since the humidity sensing film serves as a dielectric material of a capacitor, when water vapor contacts the humidity sensing film through the partially open portion provided in the upper electrode to thereby infiltrate into the thin film, water molecules are present in the thin film, such that a dielectric mixture is formed.

That is, a relative dielectric constant of the dielectric mixture is changed according to a change in ambient humidity, such that the change in humidity may be detected.

Meanwhile, in accordance with the development of a technology, miniaturization of the humidity sensor has also been required. In the case of miniaturizing humidity sensors, there have been problems, in that it may be relatively difficult to secure a sufficient exposure surface of a humidity sensing film exposed to the air.

### SUMMARY

An aspect of the present disclosure may provide a humidity sensor capable of increasing an area of a moisture sensing layer exposed to external air by forming a contact extension part in a lower electrode.

According to an aspect of the present disclosure, a humidity sensor may include: a substrate including an insulation film deposited on a surface thereof; a lower electrode formed on the substrate and including a contact extension part; a moisture sensing layer formed of a polymer material, provided on the lower electrode, and partially exposed through the contact extension part; and an upper electrode formed on the moisture sensing layer and including an open portion so as to partially expose the moisture sensing layer, wherein the contact extension part is in communication with the outside so that external air contacts the moisture sensing layer exposed through the contact extension part.

The humidity sensor may further include a circulation path allowing the contact extension part to be in communication with the outside, wherein the circulation path includes a first circulation path penetrating from the open portion of the upper electrode to the substrate and a second circulation path extended from the first circulation path along a bottom surface of the lower electrode.

The contact extension part may be formed of at least one through hole provided in the lower electrode.

The extension part may be provided in a manner in which the through holes are entirely connected to each other in one direction.

The contact extension part and the open portion may be at least partially overlapped with each other in a direction perpendicular with respect to the substrate.

The contact extension part and the open portion may be provided in different positions from each other in a direction perpendicular with respect to the substrate.

The upper electrode may include a protection layer formed thereon.

The substrate may include at least one support part protruding from the substrate, and the support part may be disposed so as to support the lower electrode.

The support part may have a pillar shape.

A portion of the moisture sensing layer corresponding to the contact extension part may be at least partially etched inwardly from the moisture sensing layer to thereby form an etched part.

A portion of the moisture sensing layer corresponding to the open portion may be at least partially etched inwardly from the moisture sensing layer to thereby form an etched part.

According to another aspect of the present disclosure, a manufacturing method of a humidity sensor may include: providing a substrate; forming a primary insulation film on the substrate; forming a sacrificial layer on one portion of the insulation film; forming a secondary insulation film on the insulation film on which the sacrificial layer is not formed; forming a lower electrode including a contact extension part on the sacrificial layer and the secondary insulation film; forming a moisture sensing layer on the lower electrode; forming an upper electrode including an open portion on the moisture sensing layer; and removing the sacrificial layer.

The forming of the lower electrode may be performed so that at least one portion of the contact extension part is provided on the sacrificial layer.

The forming of the lower electrode, the forming of the moisture sensing layer, and the forming of the upper electrode may be performed so as to expose at least one portion of the sacrificial layer to the outside.

In the providing of the substrate, a support part may be provided on one portion of the substrate to support the lower electrode.

The manufacturing method may further include forming a protection layer on the upper electrode.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view of a humidity sensor according to an exemplary embodiment of the present disclosure;

FIG. 2 is an exploded perspective view of the humidity sensor shown in FIG. 1;

FIGS. 3A and 3B are cross-sectional views taken along line A-A′ of FIG. 1 according to different examples;

FIGS. 4A and 4B are perspective views showing examples of a lower electrode;

FIG. 5 is a cross-sectional view of a humidity sensor according to another exemplary embodiment of the present disclosure;

FIGS. 6A and 6B are cross-sectional views of a humidity sensor according to another exemplary embodiment of the present disclosure;

FIGS. 7A and 7B are perspective views of a substrate shown in FIG. 6;

FIG. 8 is a flow chart of a manufacturing method of a humidity sensor according to another exemplary embodiment of the present disclosure; and

FIGS. 9A through 9I are process views showing a manufacturing method of a humidity sensor according to another exemplary embodiment of the present disclosure in a process sequence.

### DETAILED DESCRIPTION

Exemplary embodiments of the present disclosure will now be described in detail with reference to the accompanying drawings.

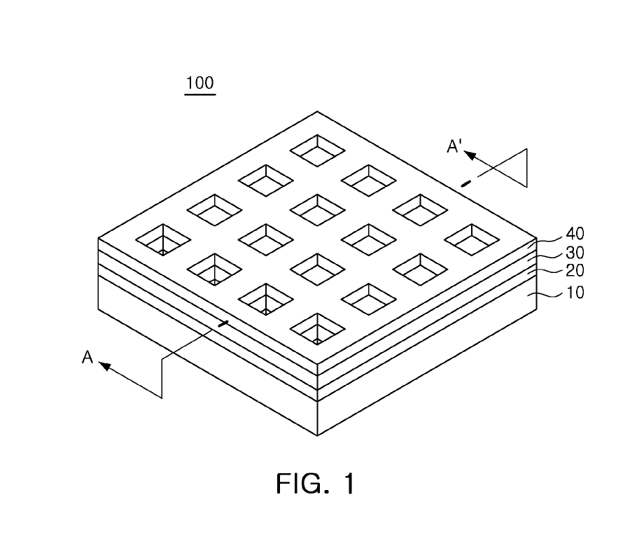

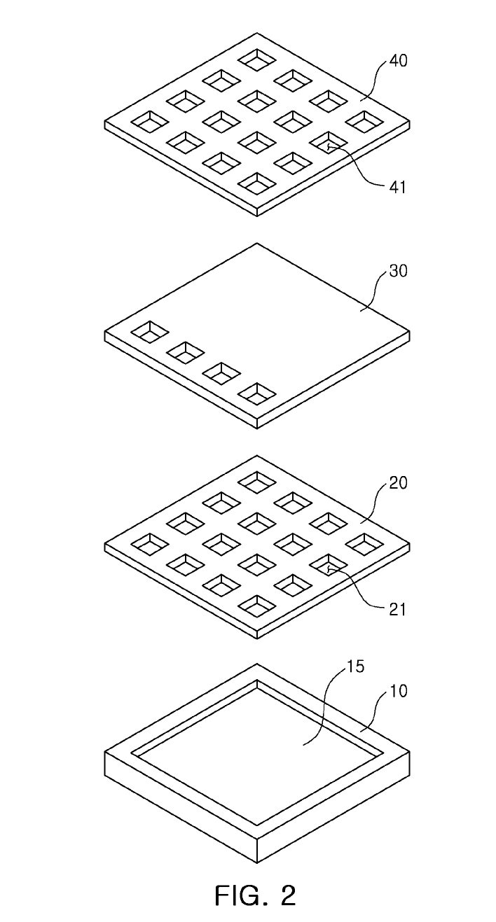

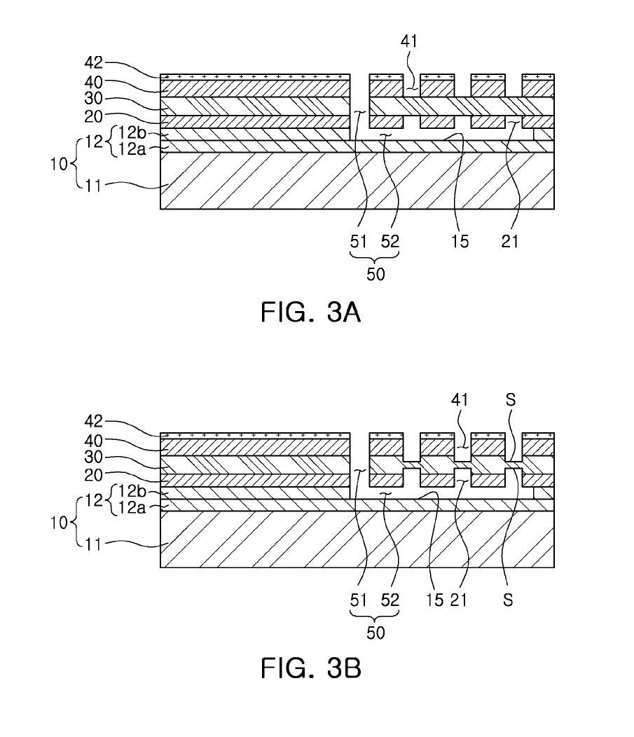

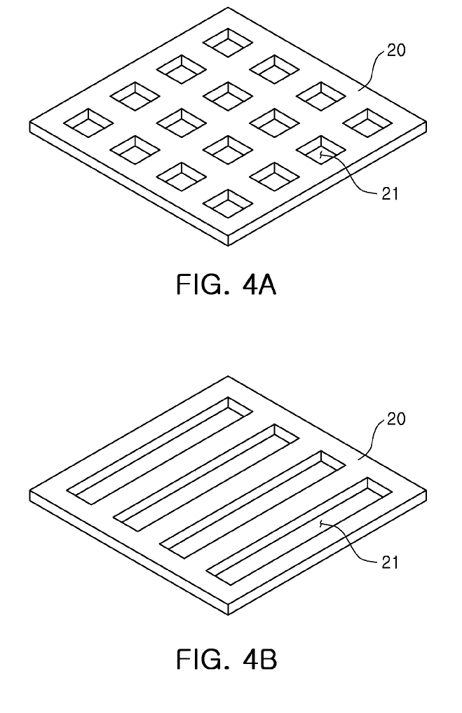

FIG. 1 is a perspective view of a humidity sensor according to an exemplary embodiment of the present disclosure, FIG. 2 is an exploded perspective view of the humidity sensor shown in FIG. 1, FIGS. 3A and 3B are cross-sectional views taken along line A-A′ of FIG. 1 according to different examples, and FIGS. 4A and 4B are perspective views showing examples of a lower electrode.

Referring to FIGS. 1 through 4B, the humidity sensor 100 according to an exemplary embodiment of the present disclosure may include a substrate 10, a lower electrode 20, a moisture sensing layer 30, an upper electrode 40, and a circulation path 50.

The substrate 10 may be composed of a plate layer 11 and an insulation film 12, wherein the plate layer 11 may be manufactured using glass, aluminum oxide, silicon (Si), or the like.

In addition, the insulation film 12 may be deposited on the plate layer 11. This insulation film 12 may be, for example, formed of SiO₂, Si₃N₄, SiOₓN_{y}, or the like.

Meanwhile, the substrate 10 may be provided with the circulation path 50. That is, the insulation film 12 deposited on the substrate may be partially removed, such that a depression part 15 may be provided therein. This depression part 15 may form the circulation path 50 connected to a bottom surface of the lower electrode 20. The circulation path 50 will be described below.

The lower electrode 20 may be formed on the substrate 10 and include a contact extension part 21. In addition, the lower electrode 20 may include a connection terminal (not shown) for connection to an external circuit and the upper electrode 40.

That is, the lower electrode 20, which is provided on the insulation film 12 of the substrate 10, may be formed by depositing and patterning a metal film such as a Cr, Al, Pt, or Au film and include the contact extension part 21 of which one portion is opened.

The contact extension part 21, which is to increase a contact area between a moisture sensing layer 30 to be described below and external air, may penetrate through one portion of the lower electrode 20 so that the moisture sensing layer 30 is exposed to external air.

Describing a shape of the contact extension part 21 in detail with reference to FIGS. 4A and 4B, the contact extension part 21 may be formed of at least one through hole (see FIG. 4A) provided in the lower electrode 20. That is, the contact extension part 21 may be formed of a plurality of through holes penetrating through the lower electrode 20, and a shape of the through hole may be various such as a circular hole shape, a polygonal hole shape, or the like.

In addition, the contact extension part 21 may be provided in a manner in which the through holes are entirely connected to each other in one direction (See FIG. 4B). Here, the contact extension part 21 provided in the lower electrode 20, which is to additionally extend a contact area between an air layer and the moisture sensing layer 30, is not limited to the above-mentioned exemplary embodiment, but may be variously changed as long as the contact extension part 21 has a structure capable of playing the role as described above. However, this case is also included in the technical idea of the present disclosure.

Meanwhile, the moisture sensing layer 30 formed of a polymer material and partially exposed through the contact extension part may be formed on the lower electrode 20.

That is, the moisture sensing layer 30 may be formed by spin-coating a polymer solution on the lower electrode 20, or the like, and as the polymer solution, a polyimide solution or a dilute photosensitive polyimide solution may be used.

In this case, a portion of the moisture sensing layer 30 may be exposed to external air through the contact extension part 21. In addition, as described above, the portion of the moisture sensing layer 30 exposed to external air may have various shapes corresponding to the shape of the contact extension part 21 of the lower electrode 10.

Meanwhile, a portion of the moisture sensing layer 30 corresponding to the contact extension part 21 or an open portion 41 to be described below is at least partially etched inwardly from the moisture sensing layer 30 to thereby form an etched part S.

In this case, the etched part S may serve to increase an area of the moisture sensing layer 30 exposed to the air layer.

The upper electrode 40 may be formed on the moisture sensing layer 30 and include an open portion provided therein so that the moisture sensing layer may be partially exposed. In addition, the upper electrode 40 may include a connection terminal (not shown) for connection to an external circuit (not shown) and the lower electrode 20.

Further, the upper electrode 40 may be formed by depositing and patterning a metal film such as a Cr, Al, Pt, or Au film on the moisture sensing layer 30, similarly to the lower electrode 20.

The open portion 41 provided in the upper electrode 40, formed to expose the moisture sensing layer 30 to external air, may penetrate through the inside of the upper electrode 40.

Here, the open portion 41 may be provided to have a shape corresponding to the contact extension par 21 of the lower electrode 20. In this case, the contact extension part 21 and the open portion 41 may be at least partially overlapped with each other in a direction perpendicular with respect to the substrate 10.

In other words, in the case in which shapes and arrangement of the open portion 41 and the contact extension part 21 are the same as each other, the open portion 41 may be positioned on the contact extension part 21 in the direction perpendicular with respect to the substrate 10, and even in the case in which shapes and arrangements of the open portion 41 and the contact extension part 21 are slightly different with respect to each other, the open portion 41 may be at least partially positioned on the contact extension part 21 in the direction perpendicular with respect to the substrate 10.

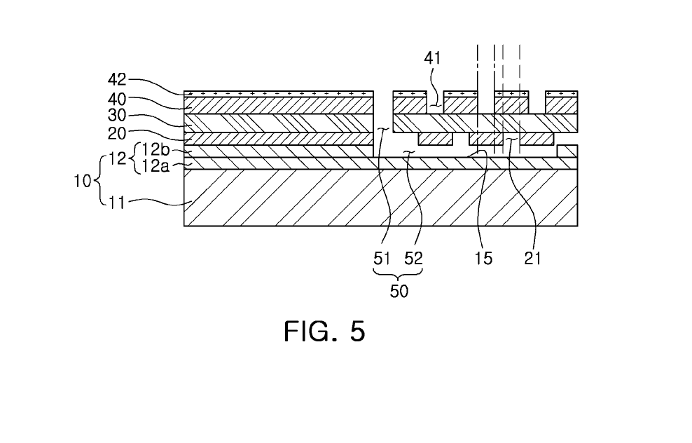

Further, referring to FIG. 5, the contact extension part 21 and the open portion 41 may be provided in different positions from each other in the direction perpendicular with respect to the substrate.

That is, arrangements of the contact extension part 21 and the open portion 41 may be variously altered, according to structural need. However, regardless of an arrangement method of the contact extension part 21 and the open portion 41, the metal plates of the lower and upper electrodes 20 and 40 may be disposed so as to be at least partially overlapped with each other in the direction perpendicular with respect to the substrate.

Meanwhile, a protection layer 42 may be provided on the upper electrode 40.

In addition, the humidity sensor 100 according to an exemplary embodiment of the present disclosure may include the circulation path 50 penetrating through the upper electrode 40, the moisture sensing layer 30, and the lower electrode 20.

Therefore, the contact extension part 21 may be in communication with the outside so that external air contacts the moisture sensing layer 30 exposed through the contact extension part 21.

Here, the circulation path 50 allowing the contact extension part to be in communication with the outside may be configured of a first circulation path 51 penetrating from the open portion 41 of the upper electrode 40 to the substrate and a second circulation path 52 extended from the first circulation path 51 along the bottom surface of the lower electrode 20 by partially removing the insulation film 12.

That is, the first circulation path 51 may penetrate from the open portion 41 of the upper electrode 40 to the substrate 10, and more specifically, may be a path formed up to the insulation film 12 deposited on the substrate 10. Here, external air may primarily flow through the first circulation path 51 to an upper portion of the substrate 10.

In addition, the first circulation path 51 may have various shapes, such as a cylindrical shape, a polygonal pillar shape, or the like, but is not necessarily limited thereto. As long as the open portion 41 and the substrate 10 are connected to each other, the shape of the first circulation path 51 may be changed.

Meanwhile, the second circulation path 52 may be extended from the first circulation path 51 along the bottom surface of the lower electrode 20 by partially removing the insulation film 12.

Therefore, external air introduced through the first circulation path 51 may flow to the bottom surface of the lower electrode 20 along the second circulation path 52. In this case, the external electrode contacts the moisture sensing layer 30 through the contact extension part 21 provided in the lower electrode 20.

Asa result, the circulation path 50 as described above may introduce an external air layer toward the bottom surface of the lower electrode 20 to allow the air layer to contact the moisture sensing layer 30 exposed to the contact extension part 21 of the lower electrode 20, such that the circulation path 50 may serve to increase a surface area of the moisture sensing layer 30 contacting external air. That is, sensitivity of the humidity sensor 100 may be improved through the series of processes as described above.

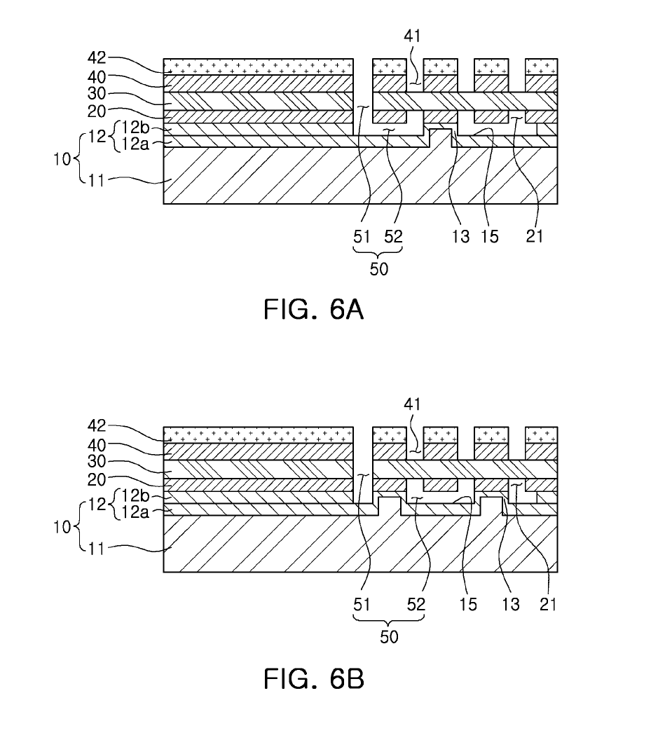

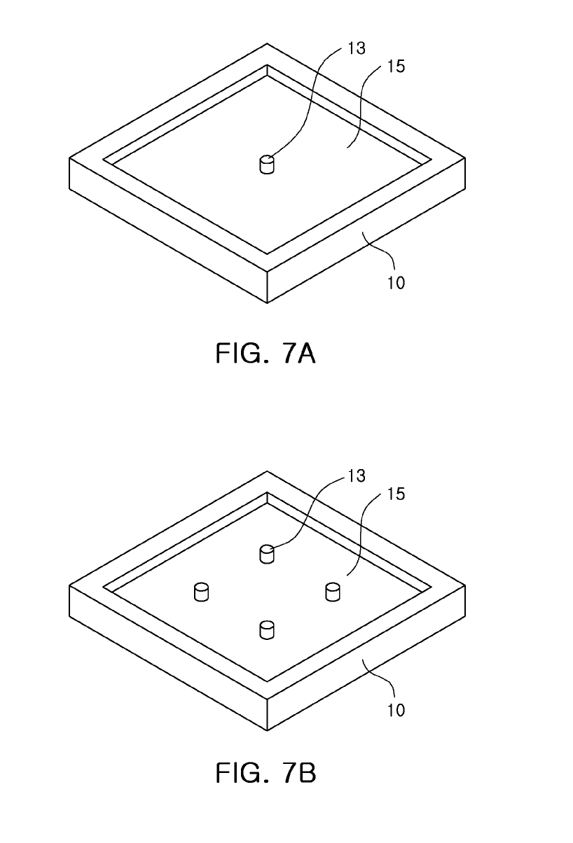

FIGS. 6A and 6B are cross-sectional views of a humidity sensor according to another exemplary embodiment of the present disclosure.

Referring to FIGS. 6A and 6B, the humidity sensor according to another exemplary embodiment of the present disclosure may include a substrate 10, a lower electrode 20, a moisture sensing layer 30, an upper electrode 40, and a circulation path 50.

Here, other configurations of the humidity sensor according to another exemplary embodiment of the present disclosure are the same as those of the humidity sensor shown in FIGS. 1 through 5 except for a configuration of the substrate 10.

Therefore, a detailed description will be omitted and be replaced with the above-mentioned description.

According to another exemplary embodiment, the substrate 10 may include a support part 13 supporting a bottom surface of the lower electrode 20, wherein the support part 13 maybe formed by a protrusion of a plate layer 11 of the substrate 10 or by depositing an insulation film 12.

That is, at least one support part 13 may be formed in a pillar shape and provided so as to contact the bottom surface of the lower electrode 20 to support the lower electrode 20, such that stability of the humidity sensor 100 may be improved.

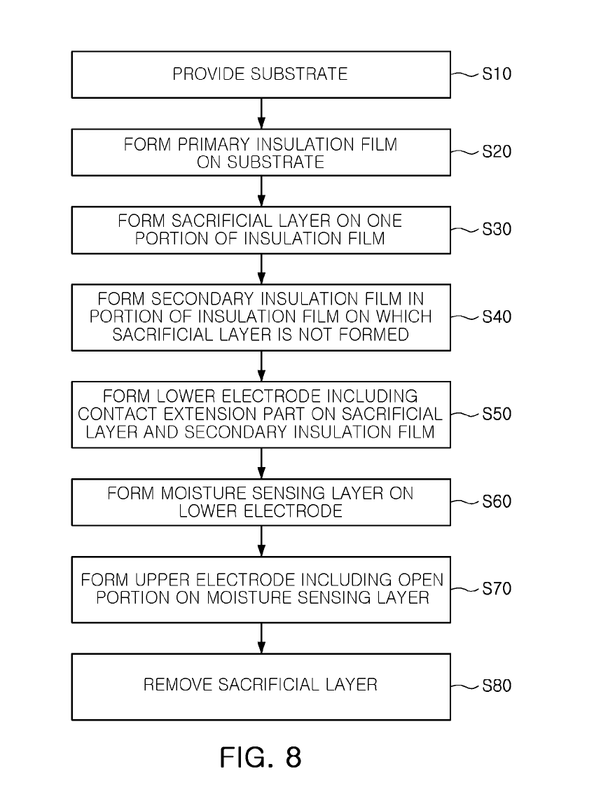

Hereinabove, structural aspects of the humidity sensors according to exemplary embodiments of the present disclosure have been described. Hereinafter, a manufacturing method of a humidity sensor according to another exemplary embodiment of the present disclosure will be described with reference to FIGS. 8 through 91.

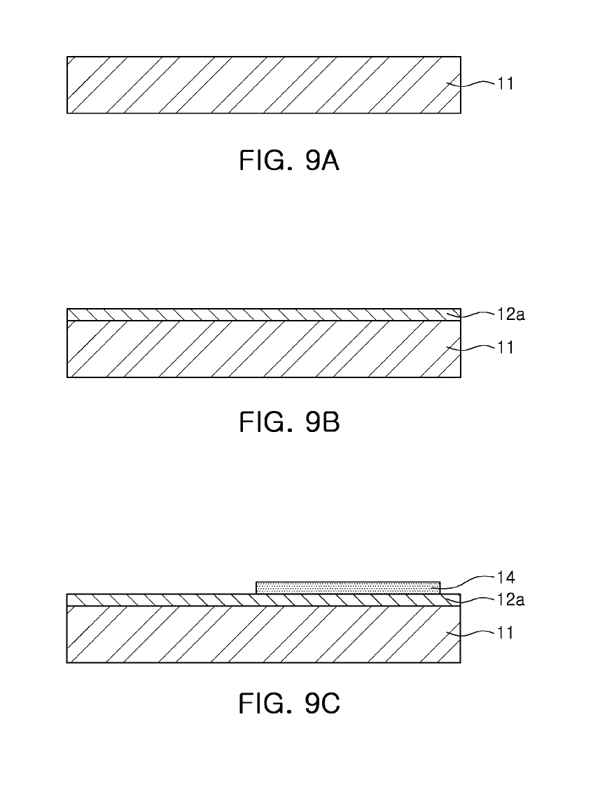

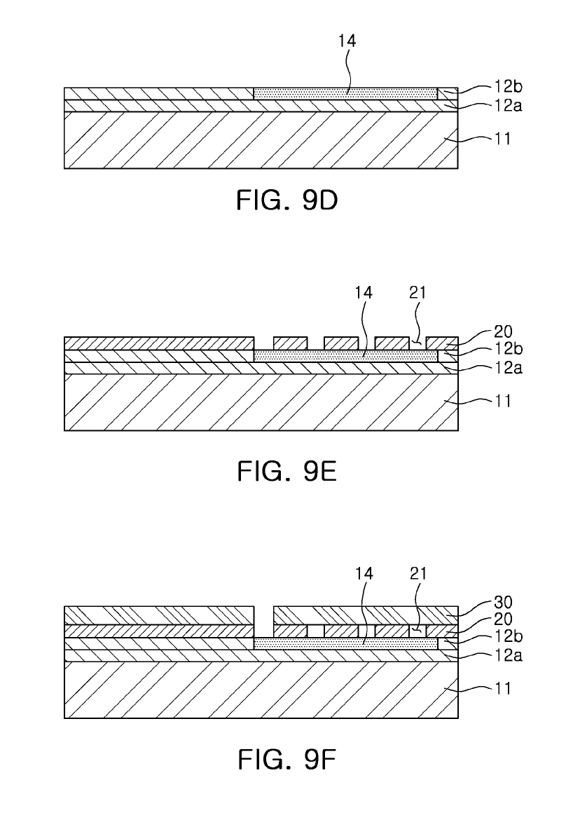

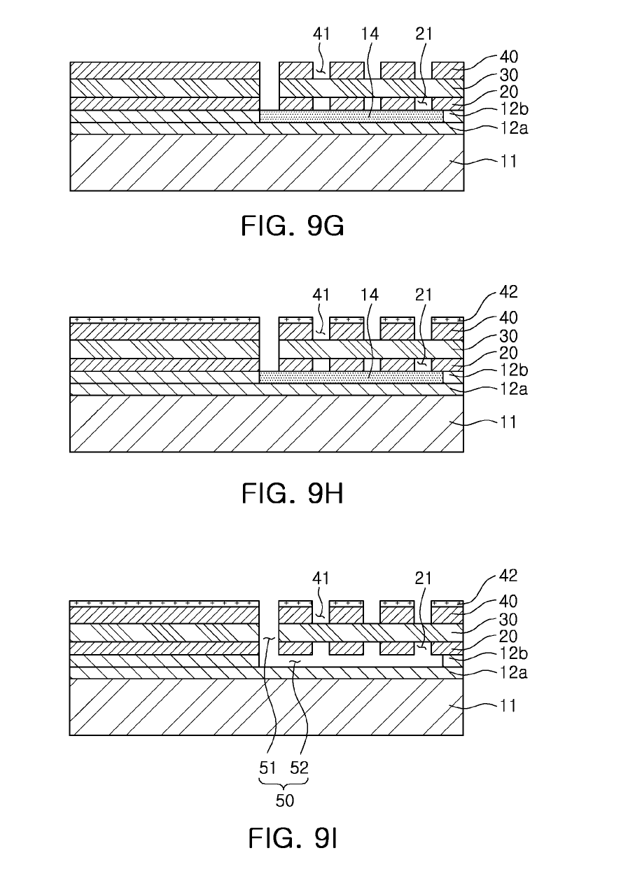

FIG. 8 is a flow chart of a manufacturing method of a humidity sensor according to another exemplary embodiment of the present disclosure, and FIGS. 9A through 91 are process views showing a manufacturing method of a humidity sensor according to another exemplary embodiment of the present disclosure in a process sequence.

Referring to FIGS. 8 through 91, in the manufacturing method of a humidity sensor according to another exemplary embodiment of the present disclosure, firstly, providing a substrate 10 may be performed (S10), wherein the substrate 10 may be formed of glass, aluminum oxide, or a silicon (Si) material. In addition, the substrate 10 may be a substrate 10 including a support part 13 formed by protrusion of one portion thereof.

After performing the providing of the substrate (S10), then, forming a primary insulation film 12a on the substrate 10 may be performed (S20). In this case, the first insulation film 12a may be formed of SiO₂, Si₃N₄, SiOₓN_{y}, or the like.

After performing the forming of the primary insulation film 12a (S20), forming a sacrificial layer 14 on one portion of the primary insulation film 12a may be performed (S30), wherein the sacrificial layer 14 may contain an oxide based component.

Then, forming a secondary insulation film 12b may be performed (S40). In this case, the secondary insulation film 12b may be formed on the primary insulation film 12a on which the sacrificial layer 14 is not formed, and formed of the same component as that of the primary insulation film 12.

Subsequently, forming a lower electrode including a contact extension part 21 on the secondary insulation film 12b and the sacrificial layer 14 may be performed (S50). The lower electrode 20 may be formed using a metal film such as Cr, Al, Pt, or Au metal film by any one method of a vacuum vapor deposition method or a physical deposition method including a sputtering method so that the contact extension part 21 positioned on the sacrificial layer 14.

When the lower electrode 20 is formed, forming of a moisture sensing layer 30 on the lower electrode 20 may be performed (S60), and after forming the moisture sensing layer 30, forming an upper electrode 40 including an open portion 41 on the moisture sensing layer 30 may be performed by the same method in the forming of the lower electrode 20 (S70).

In this case, if necessary, a protection layer 42 may be formed on the upper electrode 40.

Then, removing of sacrificial layer 14 may be performed (S80). In this case, the sacrificial layer 14 may be removed by spraying gas.

As set forth above, in the humidity sensor according to exemplary embodiments of the present disclosure, the area of the moisture sensing layer exposed to external air may be increased, such that sensitivity of the sensor capable of sensing humidity may be improved.

While exemplary embodiments have been shown and described above, it will be apparent to those skilled in the art that modifications and variations could be made without departing from the spirit and scope of the present disclosure as defined by the appended claims.

What is claimed is:

1. A humidity sensor comprising:
a substrate including an insulation film deposited on a surface thereof;
a lower electrode formed on the substrate and including a contact extension part;
a moisture sensing layer formed of a polymer material, provided on the lower electrode, and partially exposed through the contact extension part; and
an upper electrode formed on the moisture sensing layer and including an open portion so as to partially expose the moisture sensing layer,
wherein the contact extension part is in communication with the outside so that external air contacts the moisture sensing layer exposed through the contact extension part.

2. The humidity sensor of claim 1, further comprising a circulation path allowing the contact extension part to be in communication with the outside, wherein the circulation path includes a first circulation path penetrating from the open portion of the upper electrode to the substrate and a second circulation path extended from the first circulation path along a bottom surface of the lower electrode.

3. The humidity sensor of claim 1, wherein the contact extension part is formed of at least one through hole provided in the lower electrode.

4. The humidity sensor of claim 3, wherein the extension part is provided in a manner in which the through holes are entirely connected to each other in one direction.

5. The humidity sensor of claim 1, wherein the contact extension part and the open portion are at least partially overlapped with each other in a direction perpendicular with respect to the substrate.

6. The humidity sensor of claim 1, wherein the contact extension part and the open portion are provided in different positions from each other in a direction perpendicular with respect to the substrate.

7. The humidity sensor of claim 1, wherein the upper electrode includes a protection layer formed thereon.

8. The humidity sensor of claim 1, wherein the substrate includes at least one support part protruding from the substrate, and the support part disposed so as to support the lower electrode.

9. The humidity sensor of claim 8, wherein the support part has a pillar shape.

10. The humidity sensor of claim 1, wherein a portion of the moisture sensing layer corresponding to the contact extension part is at least partially etched inwardly from the moisture sensing layer to thereby form an etched part.

11. The humidity sensor of claim 1, wherein a portion of the moisture sensing layer corresponding to the open portion is at least partially etched inwardly from the moisture sensing layer to thereby form an etched part.

12. A manufacturing method of a humidity sensor, the manufacturing method comprising:
providing a substrate;
forming a primary insulation film on the substrate;
forming a sacrificial layer on one portion of the insulation film;
forming a secondary insulation film on the insulation film on which the sacrificial layer is not formed;
forming a lower electrode including a contact extension part on the sacrificial layer and the secondary insulation film;
forming a moisture sensing layer on the lower electrode;
forming an upper electrode including an open portion on the moisture sensing layer; and
removing the sacrificial layer.

13. The manufacturing method of claim 12, wherein the forming of the lower electrode is performed so that at least one portion of the contact extension part is provided on the sacrificial layer.

14. The manufacturing method of claim 12, wherein the forming of the lower electrode, the forming of the moisture sensing layer, and the forming of the upper electrode are performed so as to expose at least one portion of the sacrificial layer to the outside.

15. The manufacturing method of claim 12, wherein a support part is provided on one portion of the substrate to support the lower electrode.

16. The manufacturing method of claim 12, further comprising forming a protection layer on the upper electrode.
